(19) United States
(12) Patent Application Publication
(10) Pub. No.: US 2023/0330564 A1
(43) Pub. Date: Oct. 19, 2023

(54) GAS-LIQUID SEPARATION DEVICE

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Ho Chan An, Hwaseong-si (KR); Yeon Ho Kim, Seoul (KR); Jae Wan Kim, Hwaseong-si (KR); Ho Young Jeong, Daegu (KR); Yeong Jun Kim, Incheon (KR); Jae Yeon Kim, Hwaseong-si (KR); Man Hee Park, Suwon-si (KR); Tae Sung Kim, Seoul (KR); Yeong Kwang Cho, Osan-si (KR); Jun Ho Yun, Gumi-si (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 18/087,050

(22) Filed: Dec. 22, 2022

(30) Foreign Application Priority Data
Apr. 13, 2022 (KR) 10-2022-0045901

(51) Int. Cl. B01D 19/00

(52) U.S. Cl. CPC B01D 19/0057

(57) ABSTRACT

A gas-liquid separation device has a structure capable of increasing gas-liquid separation performance. The gas-liquid separation device includes: a housing including a fluid inlet passage, a liquid discharge passage, and a gas discharge passage; and a gas-liquid separation unit that is mounted inside the housing, disposed at a rear side of the fluid inlet passage. The gas-liquid separation unit separates a mixed fluid into a liquid and a gas by inducing rotation of the mixed fluid introduced into the housing through the fluid inlet passage. The gas-liquid separation device further includes a flow stabilization member provided at a rear end of the gas-liquid separation unit and configured to maintain a flow state of the liquid and the gas separated by the gas-liquid separation unit.

### CROSS-REFERENCE TO RELATED APPLICATION

This application claims under 35 U.S.C. § 119(a) the benefit of and priority to Korean Patent Application No. 10-2022-0045901, filed on Apr. 13, 2022, the entire contents of which are incorporated herein by reference.

### BACKGROUND

### (a) Field

The present disclosure relates to a gas-liquid separation device, and specifically, to a gas-liquid separation device for effectively separating a gas from a liquid in which gas is mixed.

### (b) Background Art

In general, a vehicle uses cooling water as an intermediate medium for recovering and removing heat generated from an engine or a battery.

Cooling water is a liquid, but a gas is dissolved therein or air bubbles are mixed therewith. The bubbles contained in the cooling water interfere with heat exchange between a heat source and the cooling water and hinder heat exchange between the cooling water and an air. In addition, noise may occur when air bubbles contained in the cooling water burst.

Accordingly, bubbles are separated from cooling water through a reservoir tank or a gas-liquid separator for storing cooling water.

A conventional gas-liquid separator separates bubbles from cooling water through performing introduction, separation, separation acceleration, and collection steps. When cooling water including bubbles is introduced into the gas-liquid separator, the gas-liquid separator separates bubbles from the cooling water through a separation step and a separation acceleration step, and individually collects the cooling water and bubbles through the collection step.

However, the conventional gas-liquid separator is configured to naturally separate the cooling water and the bubbles using a difference in specific gravity between the cooling water and the bubbles, thereby having a low gas-liquid separation performance. Furthermore, in the conventional gas-liquid separator, flow state of bubbles separated from the cooling water are not stably maintained, and thus the bubbles are mixed with the cooling water again.

In addition, the conventional gas-liquid separator is mounted as a separate object outside the reservoir tank, thereby increasing spatial constraints of the reservoir tank.

The statements in this BACKGROUND section merely provide background information related to the present disclosure and may not constitute prior art.

### SUMMARY

The present disclosure has been devised in consideration of the above point and an object of the present disclosure is to provide a gas-liquid separation device having a structure capable of increasing gas-liquid separation performance.

An object of the present disclosure is not limited to the above-mentioned object, and another object of the present disclosure not mentioned will be clearly understood by those having ordinary skill in the art from the following description.

In one embodiment of the present disclosure, a gas-liquid separation device includes: a housing including a fluid inlet passage, a liquid discharge passage, and a gas discharge passage; and a gas-liquid separation unit mounted inside the housing, disposed at a rear side of the fluid inlet passage, and configured to separate a mixed fluid into a liquid and a gas by inducing rotation of the mixed fluid introduced into the housing through the fluid inlet passage. The gas-liquid separation device further includes a flow stabilization member provided at a rear end of the gas-liquid separation unit and configured to maintain a flow state of the liquid and the gas separated by the gas-liquid separation unit.

According to an embodiment of the present disclosure, the gas-liquid separation unit may include: a conical body mounted inside the housing so that a vertex provided in the front end of the gas-liquid separation unit faces the fluid inlet passage; and curved wings provided in the shape protruding from an outer peripheral surface of the conical body and extending in a flow direction of the mixed fluid.

In addition, the wings may be formed to extend from the front end to a rear end of the conical body, and the wings may be all bent in the same direction.

In one embodiment, an outer edge and an inner edge of the wings may be formed in a cycloid curved shape.

In one embodiment, the flow stabilization member may be formed in a conical shape and be disposed inside the housing such that a vertex thereof faces the gas discharge passage.

In one embodiment, the fluid inlet passage may be formed to extend linearly at a front end of the housing.

In one embodiment, the gas-liquid separation unit may be disposed adjacent to the rear end of the fluid inlet passage.

In one embodiment, the gas discharge passage may be disposed on the opposite side of the fluid inlet passage based on the gas-liquid separation unit.

In another embodiment, the gas discharge passage is formed in shape of a pipe that penetrates a rear surface portion of the housing, and may have a rear end portion that protrudes to the outside of the housing and is bent upward.

In one embodiment, the liquid discharge passage may be formed in the shape of a pipe that extends to the lower side of the rear surface portion of the housing.

In one embodiment, the fluid inlet passage may be connected to an inlet of a liquid storage tank, and the housing may be disposed inside the liquid storage tank.

According to a method for solving items described above, the gas-liquid separation device of the present disclosure has the following effects.

First, the gas-liquid separation device of the present disclosure can significantly increase gas-liquid separation performance by including the gas-liquid separation unit and the flow stabilization member. Accordingly, when applied to a cooling water storage tank of a vehicle, the gas-liquid separation device of the present disclosure can improve both cooling performance against a heat source and heat dissipation performance against external air, thereby improving fuel efficiency and preventing noise.

Second, the gas-liquid separation device according to the present disclosure can be mounted inside the liquid storage tank, thereby minimizing spatial constraints of the liquid storage tank.

The effects of the present disclosure are not limited to the above-mentioned effects, and other effects of the present disclosure not mentioned should be clearly understood by those having ordinary skill in the art from the following description.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic cross-sectional view of a liquid storage tank to which a gas-liquid separation device according to a first embodiment of the present disclosure is applied;

FIG. 2 is a schematic cross-sectional view of the gas-liquid separation device according to the first embodiment of the present disclosure;

FIG. 3 is a perspective view illustrating a gas-liquid separation unit according to the first embodiment of the present disclosure;

FIG. 4 is a view schematically illustrating a process of separating a mixed fluid introduced into the gas-liquid separation device into a liquid and a gas according to the first embodiment of the present disclosure;

FIG. 5 is a plan view illustrating a gas-liquid separation device according to a second embodiment of the present disclosure;

FIG. 6 is a plan view illustrating a gas-liquid separation device according to a third embodiment of the present disclosure; and

FIG. 7 is a plan view illustrating a gas-liquid separation device according to a fourth embodiment of the present disclosure.

### DETAILED DESCRIPTION

The descriptions for predetermined structures and functions presented in embodiments of the present disclosure are merely made for the purpose of describing embodiments according to a concept of the present disclosure, and the embodiments according to the concept of the present disclosure may be implemented in various forms.

Throughout the present specification, when a part “includes” a constituent element, it means that the part may further include any other constituent element, not exclude any other constituent element, unless otherwise particularly described. When a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described with reference to the accompanying drawings. The matters shown in the accompanying drawings are made for easily explain the embodiments of the present disclosure, and may be different from shapes actually implemented.

As illustrated in FIG. 1, a gas-liquid separation device 100 according to a first embodiment of the present disclosure may be mounted in an inner space of a liquid storage tank 200. The inner space includes a liquid accommodation space.

Only a lower space of the inner space of the liquid storage tank 200 is filled with a liquid. The liquid storage tank 200 includes an inlet 210 for introducing liquid and an outlet 220 for discharging liquid. The inlet 210 is provided on the liquid storage tank 200, and the outlet 220 is provided underneath the liquid storage tank 200. The gas-liquid separation device 100 may be disposed in an upper space of the inner space of the liquid storage tank 200. The upper space is a gas accommodation space.

For example, the liquid storage tank 200 may be a cooling water storage tank for storing cooling water. The cooling water may be used as an intermediate medium for recovering and removing heat generated from an engine or a battery of a vehicle. The cooling water is a liquid, but a gas such as air may be dissolved therein or air bubbles may be mixed therewith.

In the present disclosure, a liquid with which gas is mixed or a liquid with which air bubbles are mixed is referred to as “fluid” or “mixed fluid”. In addition, unless specifically described in the present disclosure, descriptions such as “front end”, “rear end”, “front side”, and “rear side” are based on a flow direction of the mixed fluid.

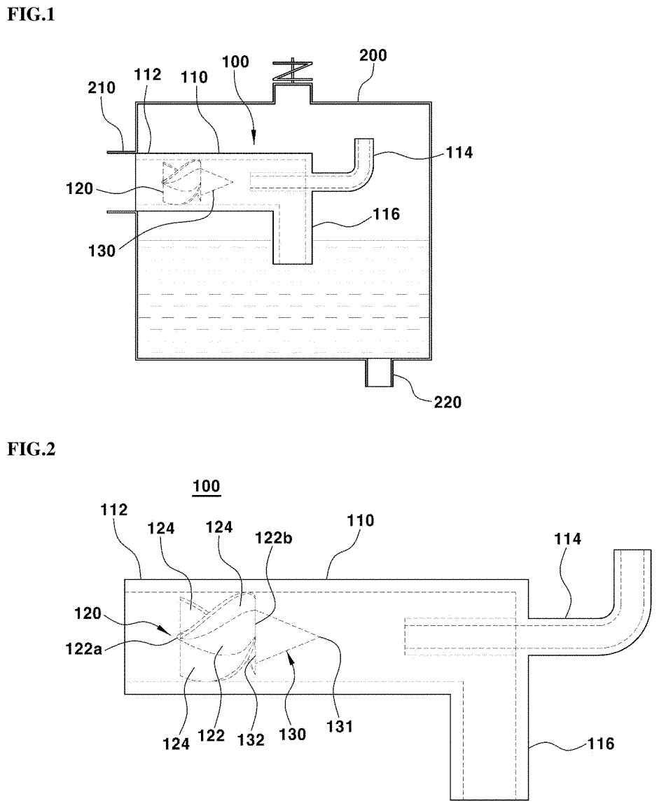

As illustrated in FIGS. 1 and 2, the gas-liquid separation device 100 includes a housing 110, a gas-liquid separation unit 120, and a flow stabilization member 130.

The housing 110 has an inner space in which a mixed fluid may flow. The inner space of the housing 110 may serve as a flow path. Specifically, the housing 110 may be formed in a linear pipe structure having a predetermined length and a predetermined radius. The housing 110 has a fluid inlet passage 112, a gas discharge passage 114, and a liquid discharge passage 116.

The fluid inlet passage 112 is integrally provided at a front end of the housing 110. The fluid inlet passage 112 may be formed in a linear pipe structure having the same radius as the housing 110. In other words, the fluid inlet passage 112 may extend in the shape of a straight pipe at the front end of the housing 110.

In one embodiment, the fluid inlet passage 112 may be directly mounted and connected to the inlet 210 of the liquid storage tank 200. The fluid inlet passage 112 may be formed to have the same radius as the inlet 210. The fluid inlet passage 112 may be coaxially disposed with the housing 110 and the inlet 210. The housing 110 may be mounted and disposed inside the liquid storage tank 200. The housing 110 may be disposed in the upper space of the inner space of the liquid storage tank 200.

In another embodiment, the fluid inlet passage 112 is disposed at front side of the gas-liquid separation unit 120 and guides the flow of the mixed fluid to the gas-liquid separation unit 120. The fluid inlet passage 112 is formed in a straight line so that the mixed fluid flows smoothly toward the gas-liquid separation unit 120. When the mixed fluid easily flows toward the gas-liquid separation unit 120, a rotational force of the mixed fluid by the gas-liquid separation unit 120 is advantageously generated.

In one embodiment, the gas discharge passage 114 is disposed on the opposite side of the fluid inlet passage 112 with respect to the gas-liquid separation unit 120. The gas discharge passage 114 is provided on a rear surface portion of the housing 110. The gas discharge passage 114 is formed in the shape of a straight pipe that penetrates the rear surface portion of the housing 110. A front end portion of the gas discharge passage 114 extends from the rear surface portion of the housing 110 toward the fluid inlet passage 112, and a rear end portion of the gas discharge passage 114 extends toward the opposite side of the fluid inlet passage 112 from the rear surface portion of the housing 110. In other words, the gas discharge passage 114 penetrates the rear surface portion of the housing 110 and protrudes outward from the housing 110.

In addition, the gas discharge passage 114 has a rear end portion protruding to the outside of the housing 110 which is bent upward and extended. In this form, the rear end portion of the gas discharge passage 114 is bent to the opposite side of the lower space of the liquid storage tank 200.

In addition, the gas discharge passage 114 is disposed in a radial center of the housing 110. In this form, the gas discharge passage 114 may be concentrically disposed with the housing 110 and the fluid inlet passage 112. The gas discharge passage 114 is formed to have a radius smaller than a radius of each of the housing 110 and the fluid inlet passage 112. For example, as illustrated in FIG. 2, the gas discharge passage 114 may be formed to have a radius smaller than half of the radius of the housing 110.

In addition, the front end portion of the gas discharge passage 114 may be disposed on the same line as a vertex 131 of the flow stabilization member 130. Specifically, in front end portion of the gas discharge passage 114, a central axis thereof in the radial direction may be disposed on the same line as the vertex 131 of the flow stabilization member 130. In other words, a radial center of the gas discharge passage 114 may be disposed on a central axis of the flow stabilization member 130.

The gas discharge passage 114 with the aforementioned structure may facilitate an inflow of a gas separated from a liquid and prevent an inflow of the liquid.

In one embodiment, the liquid discharge passage 116 may be provided at a lower end portion of the housing 110. The liquid discharge passage 116 may be formed in the shape of a pipe that extends downward from the rear surface portion of the housing 110. The liquid discharge passage 116 may extend perpendicular to the axial direction of the housing 110. That is, the liquid discharge passage 116 may extend in a direction vertical to the fluid inlet passage 112 and the front end portion of the gas discharge passage 114. The liquid discharge passage 116 may be disposed below the front end portion of the gas discharge passage 114. The liquid discharge passage 116 may extend in a direction opposite to a direction in which the rear end portion of the gas discharge passage 114 is bent.

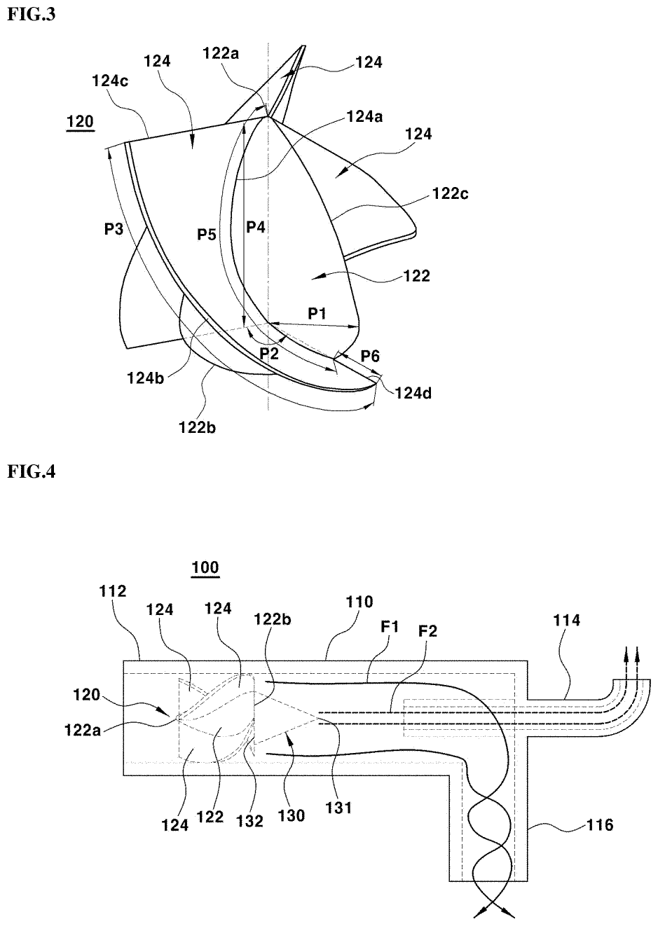

As illustrated in FIGS. 2 and 3, the gas-liquid separation unit 120 is configured to separate the mixed fluid, introduced into the housing 110 through the fluid inlet passage 112, into a gas and a liquid. The gas-liquid separation unit 120 is mounted inside the housing 110 and disposed at a rear side of the fluid inlet passage 112. The gas-liquid separation unit 120 may be disposed adjacent to a rear end of the fluid inlet passage 112.

The gas-liquid separation unit 120 induces and generates rotation of a mixed fluid introduced into the housing 110, thereby separating the mixed fluid into a liquid and a gas. In other words, the gas-liquid separation unit 120 generates a rotational force of the mixed fluid to separate the gas from the mixed fluid. The mixed fluid consists of a liquid and a gas mixed with the liquid.

In one embodiment, the gas-liquid separation unit 120 includes a conical body 122 and a plurality of a curved wings 124 provided on the conical body 122. The gas-liquid separation unit 120 according to the first embodiment of the present disclosure includes three curved wings 124 provided on an outer peripheral surface of the conical body 122.

The conical body 122 is mounted inside the housing 110 so that a vertex 122a thereof faces the fluid inlet passage 112. In this form, the conical body 122 may be coaxially disposed with the housing 110.

Based on the flow direction of the mixed fluid, the conical body 122 has the vertex 122a provided at a front end thereof and a circular plane provided at a rear end thereof. The circular plane is a bottom surface 122b of the conical body 122. The flow direction of the mixed fluid is the flow direction of a mixed fluid introduced into the fluid inlet passage 112.

The conical body 122 has a conical structure in which an outer peripheral surface thereof has a shape convex outward. The conical body 122 has a curved shape in which the outer peripheral surface thereof is one surface. The outer peripheral surface of the conical body 122 is a surface between the front and rear ends of the conical body 122. In other words, the outer peripheral surface of the conical body 122 is a side surface 122c between the vertex 122a and the bottom surface 122b of the conical body 122.

In another embodiment, the wings 124 are provided to protrude from the outer peripheral surface of the conical body 122. The wings 124 are spaced apart from the outer peripheral surface of the conical body 122. As illustrated in FIG. 3, the wings 124 may be disposed at equal intervals on the outer peripheral surface of the conical body 122. All of the wings 124 are formed in the same structure. All of the wings 124 are formed to be bent in the same direction on the outer peripheral surface of the conical body 122. In other words, the wings 124 are formed to be bent in one predetermined direction on the outer peripheral surface of the conical body 122.

The wings 124 extend on the outer peripheral surface of the conical body 122 in the flow direction of the mixed fluid. In other words, the wings 124 extend in the axial direction of the conical body 122. In addition, the wings 124 extend from the front end to the rear end of the conical body 122. In other words, the wings 124 are formed to extend from the vertex 122a to an edge of the bottom surface 122b of the conical body 122.

In another embodiment, the wings 124 are formed to have a cycloid curved edge to increase gas-liquid separation performance. The wings 124 have an inner edge 124a and an outer edge 124b formed in a cycloid curve shape. The inner edge 124a is directly adjacent to the outer peripheral surface of the conical body 122, and the outer edge 124b is spaced apart from the outer peripheral surface of the conical body 122. In addition, the wings 124 have a front end edge 124c and a rear end edge 124d that connect an end of the inner edge 124a and an end of the outer edge 124b. A circumference of the wing 124 includes the inner edge 124a, the outer edge 124b, the front end edge 124c, and the rear end edge 124d.

A length P3 of the outer edge 124b may be calculated as shown in Equation 1 below, and a length P5 of the inner edge 124a may be calculated as shown in Equation 2 below.

$$P 3 = 2 \times ( P 1 + P 6 ) \times {\int }_{0}^{θ} ( sin \frac{θ}{2} ) d θ \qquad Equation 1$$

$$P 5 = 2 \times P 1 \times {\int }_{0}^{θ} ( sin \frac{θ}{2} ) d θ \qquad Equation 2$$

where, P1 is a radius of the bottom surface of the conical body 122, θ is a rotation angle of a first circle and a second circle, and P6 is a length of the rear end edge 124d.

The inner edge 124a is formed in a cycloid curved shape drawn by a predetermined point around the first circle when the first circle rolls in a straight line. The first circle may have the same radius as the radius P1 of the conical body 122. The outer edge 124b is formed in a cycloid curved shape drawn by a predetermined point around the second circle when the second circle rolls in a straight line. The second circle may have the same radius as the sum of the radius P1 of the conical body 122 and the length P6 of the rear end edge 124d.

In addition, the gas-liquid separation unit 120 may determine a rotational force of the mixed fluid by parameters such as the radius P1 and a height P4 of the conical body 122, a spacing angle P2 between the wings 124, the number of the wings 124, the length P5 of the inner edge 124a, and the length P3 of the outer edge 124b. The spacing angle P2 is a spacing angle between the rear end edges 124d of adjacent wings 124. The gas-liquid separation unit 120 may increase the gas-liquid separation performance by increasing the rotational force of the mixed fluid.

The flow stabilization member 130 is provided at a rear end of the gas-liquid separation unit 120. The flow stabilization member 130 may be attached to the rear end of the gas-liquid separation unit 120 or may extend to the rear end of the gas-liquid separation unit 120. The flow stabilization member 130 may be integrally provided at the rear end of the conical body 122.

The flow stabilization member 130 is configured to maintain a flow of liquid and gas separated by the gas-liquid separation unit 120. In other words, the flow stabilization member 130 induces a flow state and a flow direction of the liquid and gas separated by the gas-liquid separation unit 120 to be individually maintained. In other words, the flow stabilization member 130 induces the liquid and the gas to flow while being kept separated from each other.

To this end, the flow stabilization member 130 may be formed in a conical shape structure. The flow stabilization member 130 having a conical shape is disposed inside the housing 110 such that the vertex 131 provided at a rear end thereof faces an opposite side of the vertex 122a provided at a front end of the gas-liquid separation unit 120.

In this case, the vertex 131 of the flow stabilization member 130 faces the gas discharge passage 114. In addition, a bottom surface 132 provided at the front end of the flow stabilization member 130 is bonded adjacent to the rear end of the conical body 122.

For one example, the flow stabilization member 130 may be formed in a shape similar to the conical body 122. As another example, the flow stabilization member 130 may be formed in the same shape as the conical body 122.

Since the flow stabilization member 130 is formed in a conical shape, the flow stabilization member 130 may induce the gas, separated from the liquid by the gas-liquid separation unit 120 to flow to the center in the radial direction of the housing 110. Accordingly, the gas is induced to flow toward the gas discharge passage 114 and is not mixed with the liquid flowing along an inner circumferential surface of the housing 110.

In more detail, the flow stabilization member 130 induces the gas separated from the liquid by the conical structure to be further collected the center in the radial direction of the housing 110, thereby preventing the gas from being mixed with the liquid again. The flow stabilization member 130 induces the flow state of the gas separated from the liquid to be stably maintained.

More specifically, the flow stabilization member 130 maintains to the maximum a rotational energy of the gas separated from the liquid by the gas-liquid separation unit 120. Accordingly, the gas may move from the center in the radial direction of the housing 110 to the gas discharge passage 114

When the flow stabilization member 130 is not provided at the rear end of the gas-liquid separation unit 120, the rear end of the gas-liquid separation unit 120 is perpendicular to the flow direction of the mixed fluid, which increases possibility of loss in the rotational energy of the liquid and gas at the rear end of the gas-liquid separation unit 120.

A process in which the mixed fluid introduced into the housing 110 is separated into a liquid and a gas is further described with reference to FIG. 4. In FIG. 4, arrow F1 schematically indicates a flow of liquid, and arrow F2 schematically indicates a flow of gas.

The mixed fluid may be introduced into the housing 110 at a predetermined flow speed through the fluid inlet passage 112. The mixed fluid introduced into the housing 110 rotates while flowing along the wings 124 of the gas-liquid separation unit 120. The mixed fluid is separated into a liquid and a gas by a rotational force generated by the wings 124. In this case, as illustrated in FIG. 4, a relatively high-density liquid flows toward the inner circumferential surface of the housing 110 by the rotational force, and a relatively low-density gas flows toward the center in the radial direction of the housing 110. Accordingly, the mixed fluid is separated into the liquid and the gas while passing through the gas-liquid separation unit 120.

The flow of the liquid and gas separated through the gas-liquid separation unit 120 is further stabilized by the flow stabilization member 130. Accordingly, the liquid is in close contact with the inner circumferential surface of the housing 110 and flows along the inner circumferential surface (refer to “F1” in FIG. 4), and the gas is separated from the liquid and gathers into the center in the radial direction of the housing 110 and flows in the axial direction of the housing 110 (refer to “F2” in FIG. 4). The liquid is introduced into the liquid discharge passage 116 from a rear end portion of the housing 110 and an outside of the gas discharge passage 114, and flows spirally along an inner circumferential surface of the liquid discharge passage 116 to be discharged to the outside of the housing 110. The gas is introduced into the gas discharge passage 114 from the center in the radial direction of the housing 110, and the gas is discharged to the outside of the housing 110 through the gas discharge passage 114.

The liquid is discharged to the lower side of the housing 110 along the liquid discharge passage 116, and the gas is discharged to the upper side of the housing 110 along the gas discharge passage 114. In this case, the liquid is discharged to and collected in the lower space of the liquid storage tank 200, and the gas is discharged to and collected in the upper space of the liquid storage tank 200.

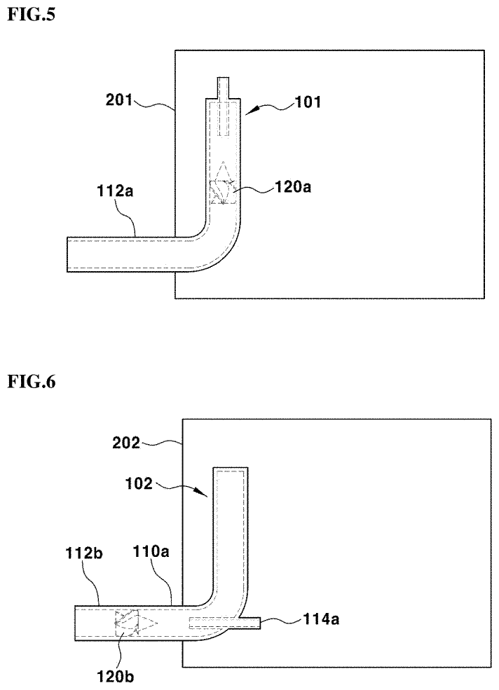

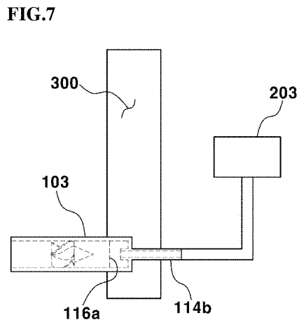

Meanwhile, FIG. 5 is a plan view illustrating a gas-liquid separation device according to a second embodiment of the present disclosure, FIG. 6 is a plan view illustrating a gas-liquid separation device according to a third embodiment of the present disclosure, and FIG. 7 is a plan view illustrating a gas-liquid separation device according to a fourth embodiment of the present disclosure.

As illustrated in FIG. 5, a gas-liquid separation device 101 according to the second embodiment is disposed at a place which is less influenced by a liquid stored in a liquid storage tank 201. In this embodiment, a fluid inlet passage 112a of the gas-liquid separation device 101 may be extended in a curved shape. In this case, a rear end portion of the fluid inlet passage 112a is formed in a linear shape. The rear end portion of the fluid inlet passage 112a disposed at a front side of a gas-liquid separation unit 120a is formed in a straight line to advantageously generate the rotational force of a mixed fluid by using the gas-liquid separation unit 120a. For example, the fluid inlet passage 112a may be bent in an L-shape.

In addition, as illustrated in FIG. 6, a gas-liquid separation device 102 according to the third embodiment includes a linear fluid inlet passage 112b and a curved housing 110a. The housing 110a may be mounted on a liquid storage tank 202 in such a manner that a front end portion thereof penetrates the liquid storage tank 202. A gas-liquid separation unit 120b is disposed at the front end portion of the housing 110a, and the front end portion of the housing 110a extends in a straight line. The fluid inlet passage 112b is connected in a straight line to the front end portion of the housing 110a. In this case, a gas discharge passage 114a may be provided at the front end portion of the housing 110a and disposed at a rear side of the gas-liquid separation unit 120b. The gas discharge passage 114a may penetrate a central portion of the housing 110a and extend to the outside of the housing 110a.

In addition, as illustrated in FIG. 7, a gas-liquid separation device 103 according to the fourth embodiment may include a liquid discharge passage 116a disposed in a space in which the liquid flows (i.e., liquid flow space 300). When the liquid discharge passage 116a is directly disposed in the liquid flow space 300, a gas discharge passage 114b may extend to the outside of the liquid flow space 300 to be connected to a liquid storage tank 203. For example, the liquid flow space may be an inner space of a cooling water manifold.

While various embodiments of the present disclosure have been described above in detail, terms or words used in this specification and claims are not limited in any ordinary or dictionary sense, the scope of the present disclosure is not limited to each of the above-described embodiments. Various modifications and improvements by those having ordinary skill in the art using the basic concept of the present disclosure should also be included in the scope of the present disclosure.

What is claimed is:

1. A gas-liquid separation device comprising:
a housing including a fluid inlet passage, a liquid discharge passage, and a gas discharge passage;
a gas-liquid separation unit mounted inside the housing and disposed at a rear side of the fluid inlet passage, the gas-liquid separation unit configured to separate a mixed fluid into a liquid and a gas by inducing rotation of the mixed fluid introduced into the housing through the fluid inlet passage; and
a flow stabilization member provided at a rear end of the gas-liquid separation unit and configured to maintain a flow state of the liquid and the gas separated by the gas-liquid separation unit.

2. The gas-liquid separation device of claim 1,
wherein the gas-liquid separation unit comprises:
a conical body mounted inside the housing so that a vertex provided at a front end thereof faces the fluid inlet passage; and
curved wings protruding from an outer peripheral surface of the conical body and extending in a flow direction of the mixed fluid.

3. The gas-liquid separation device of claim 2,
wherein the curved wings are formed to extend from the front end to a rear end of the conical body, and are all bent in the same direction.

4. The gas-liquid separation device of claim 2,
wherein an outer edge and an inner edge of the curved wings is formed in a cycloid curved shape.

5. The gas-liquid separation device of claim 1,
wherein the flow stabilization member is formed in a conical shape and disposed inside the housing such that a vertex thereof faces the gas discharge passage.

6. The gas-liquid separation device of claim 1,
wherein the fluid inlet passage is formed to extend linearly at a front end of the housing.

7. The gas-liquid separation device of claim 1,
wherein the gas-liquid separation unit is disposed adjacent to a rear end of the fluid inlet passage.

8. The gas-liquid separation device of claim 1,
wherein the gas discharge passage is disposed on an opposite side of the fluid inlet passage based on the gas-liquid separation unit.

9. The gas-liquid separation device of claim 1,
wherein the gas discharge passage is formed in shape of a pipe that penetrates a rear surface portion of the housing, and the gas discharge passage includes a rear end portion that protrudes to an outside of the housing and is bent upward.

10. The gas-liquid separation device of claim 1,
wherein the liquid discharge passage is formed in shape of a pipe that extends to a lower side of a rear surface portion of the housing.

11. The gas-liquid separation device of claim 1,
wherein the fluid inlet passage is connected to an inlet of a liquid storage tank, and the housing is disposed inside the liquid storage tank.
